(19) United States
(12) Patent Application Publication
(10) Pub. No.: US 2002/0095538 A1
(43) Pub. Date: Jul. 18, 2002

(54) Portable information storage module for information shopping

(76) Inventor: Daniel R. Marshall, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/759,867

(22) Filed: Jan. 12, 2001

(51) Int. Cl. G06F 13/12

(52) U.S. Cl. 710/74

(57) ABSTRACT

A portable entertainment media storage module allows an individual to capture one or more entertainment media into the module for later retrieval and consumption. The module includes a high capacity atomic resolution memory device and a communication interface. The memory device is capable of storing one or more packets of entertainment media while the communication interface facilitates reading from and writing to the memory device. In one example embodiment, an individual can capture a packet of entertainment media, such as movie, book, or music CD, from an information library and store that entertainment packet in the module for later consumption using a media player (e.g., CD player, notebook computer, etc.). In one embodiment, the memory device includes an atomic resolution storage device, which is subminiature in size, allowing it to be contained within a small housing such as a pendant, has low power requirements, and provides for non-volatile storage of large amounts of data, including video.

### CROSS REFERENCE TO RELATED APPLICATIONS

This Utility Patent Application is related to U.S. patent application entitled “PERSONAL MOVIE STORAGE MODULE” having Attorney Docket No. HP PDNO 10002343-1 filed herewith.

### THE FIELD OF THE INVENTION

The present invention relates generally to portable information storage and, in particular, to portable entertainment media storage devices.

### BACKGROUND OF THE INVENTION

Our quest for information appears to have no boundaries. In particular, our appetite for entertainment is close to insatiable. The twenty-first century person consumes books, music, and movies at every turn. The only limit appears to be our ability to carry all of these media with us for immediate use and to continuously have a way of accessing the media.

For example, an individual can go to a shopping center or bookstore and find books in print or audiotape, music on CD's or audiotape, and movies in VHS or DVD formats, as well as other entertainment media. Unfortunately, carrying and then consuming all or several of these media at one time is cumbersome. For example, when planning to travel in an airplane, an individual might buy a book and a CD with the intention of reading the book and listening to the CD on the airplane. However, handling carry-on luggage as well a CD player, DVD player, and/or book while boarding a plane or shuffling through the airport is awkward at best.

In addition, on an international or national scale, it appears relatively wasteful to produce millions of books, CD's, DVDs, videotapes, audiotapes, etc., each to be consumed by a single individual or family. Millions of pounds of paper and plastic is produced, all of which will ultimately end up in landfills.

Finally, with the entertainment industry exhibiting an ever-increasing proficiency in producing more books, more movies, and more music than ever before, this onslaught of information will not abate. Accordingly, conventional ways of handling and consuming entertainment media can withstand great improvement.

### SUMMARY OF THE INVENTION

The present invention provides a portable entertainment media storage module. The portable entertainment media storage module includes a storage device having an atomic resolution storage memory component capable of storing at least one entertainment media packet. A communication interface communicates to and from the memory component of the storage module.

### BRIEF DESCRIPTION OF THE DRAWINGS

FIG. 1 is a schematic illustration of a portable entertainment media storage module and entertainment library, according to an embodiment of the present invention.

FIG. 2 is a schematic illustration of a portable entertainment media storage module in communication with several media access devices, according to an embodiment of the present invention.

FIG. 3 is a schematic illustration of a portable entertainment media storage module, according to an embodiment of the present invention.

FIG. 4 is a side view illustrating one exemplary embodiment of a storage device used in a portable entertainment media storage module in accordance with the present invention.

FIG. 5 is a simplified schematic diagram illustrating one exemplary embodiment of storing information within the storage device illustrated in FIG. 4.

FIG. 6 is a top view illustrating one exemplary embodiment of a storage device used in a portable entertainment media storage module in accordance with the present invention taken along lines 4-4 of FIG. 4.

FIG. 7 is a diagram illustrating one exemplary embodiment of field emitters reading from storage areas of the storage device of FIG. 4.

FIG. 8 is schematic illustration of a portable entertainment media storage module, according to an embodiment of the present invention.

FIG. 9 is perspective view of an entertainment media storage bracelet, according to an embodiment of the present invention.

FIG. 10 is a schematic illustration of an entertainment media storage watch, according to an embodiment of the present invention.

FIG. 11 is a schematic illustration of an entertainment media storage cellular phone, according to an embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

A portable entertainment media storage module of the present invention allows an individual to capture one or more entertainment media into the module for later retrieval and consumption. The module includes a high capacity memory component and a communication interface. The memory component is capable of storing one or more packets of entertainment media while the communication interface facilitates reading from and writing to the memory component at a higher transfer rate.

In one example embodiment, an individual can capture a packet of entertainment media, such as movie, book, or music CD, from an information library and store that entertainment packet in the personal entertainment media storage module for later consumption. The book or music is retrieved from the module at the individual's convenience using a media player (e.g., CD player, notebook computer, etc.). The communication interface preferably uses wireless technology so that no cables are required.

In one preferred embodiment, the memory component of the storage module includes an atomic resolution storage device. In alternative embodiments, the memory component optionally comprises other suitable high capacity storage devices. The atomic resolution storage memory component used in the portable storage module according to the present invention is subminiature in size, allowing it to be contained within a small housing such as a pendant, has low power requirements, and provides for non-volatile storage of large amounts of data, including video. The term “atomic resolution storage device” memory as used herein is defined as a non-volatile memory storage device capable of storing a large volume of data, such as megabytes to gigabytes of data points, within a relatively small storage area and requiring very low power consumption. The atomic resolution storage device includes a field emitter, a storage medium, and a micromover and associated circuitry for the reading and writing of data. Preferably, the atomic resolution storage device includes a plurality of spaced apart field emitters, wherein each field emitter is responsible for a number of storage areas on the storage medium.

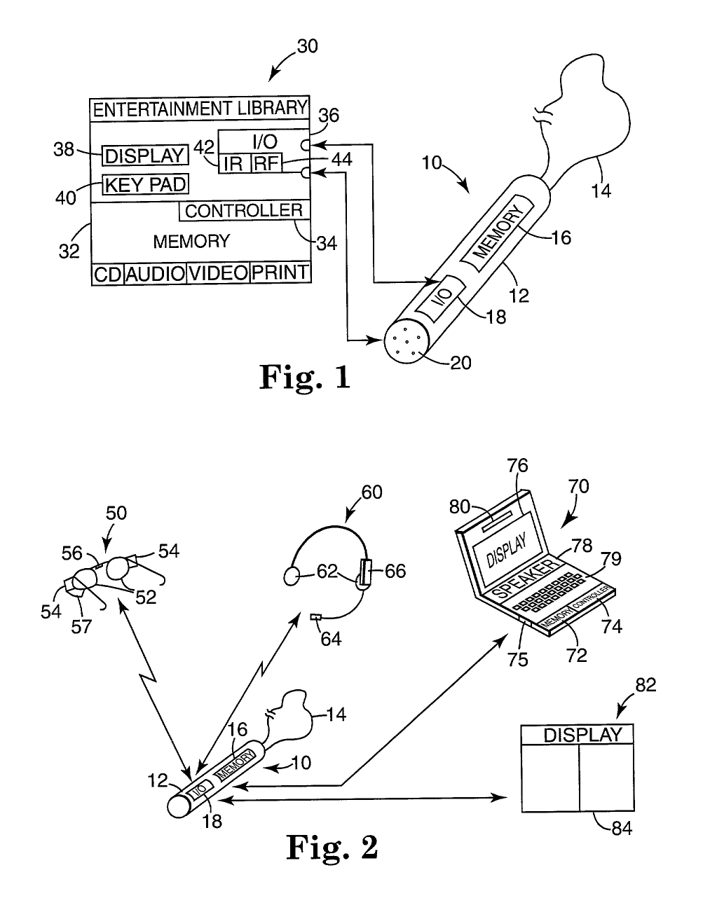

A portable entertainment media storage module 10 of the present invention is shown generally in FIG. 1 along with entertainment library 30. Module 10 is exaggerated in size relative to entertainment library 30 for illustrative purposes. Module 10 includes housing 12 and band 14 with housing 12 containing memory 16 and input/output interface 18. Band 14 permits wearing housing 12 about a user's neck, wrist or other body part. Housing 12 preferably is any shape or size that permits convenient carrying within a pocket or on a user's body. For example, housing 12 can be the size and shape of a pen, or even smaller objects, such as a pendant or necklace locket.

In one embodiment, communication interface 18 includes any suitable wireless transmission technology (e.g. radiofrequency, infrared, etc.) that readily permits communication to and from module 10. Communication preferably is accomplished through a broadband (i.e., high bandwidth) format, although more conventional frequency bandwidths can be used. Communication interface 18 is communicatively coupled to memory 16 and preferably is used for programming memory 16 to determine the manner in which memory 16 will operate and communicate with information library 30, as well as a host of other devices used for accessing memory 16. In addition, module 10 optionally includes connector 20 which optionally communicates with communication interface 18 to provide a non-wireless communication path.

Memory 16 of module 10 is preferably a high capacity storage device, and which is more preferably of a silicon-based construction. In one preferred embodiment, memory 16 is an atomic resolution storage (ARS) device capable of storing a large volume of data, such as megabytes to gigabytes of data points, within a relatively small storage area. The atomic resolution storage device is a low power consumption storage device. In one embodiment, the atomic resolution storage device requires less than 500 mW to operate. In one preferred embodiment, ARS module of memory 16 has a size of about 1 square millimeter, suitable to be carried within a portable module. In addition, ARS module of memory 16 can include its own modules that correspond to the functions of a logic controller. Finally, other subminiature memory devices, known to those skilled in the art, that have a high storage capacity with relatively low power consumption can be used in place of ARS module of memory 16. However, these alternative devices may limit the volume and quality of data recorded since these devices will not be as beneficial as ARS module of memory 16 relative to the power consumption requirements and amount of memory storage.

One atomic resolution storage device suitable for use in portable entertainment media module according to the present invention is disclosed in U.S. Pat. No. 5,557,596 to Gibson et al., issued Sep. 17, 1996, entitled “Ultra-High Density Storage Device.” Other suitable high density storage devices suitable for use as memory 16 with the portable entertainment media storage module according to the present invention will become apparent to those skilled in the art after reading the present application. One exemplary embodiment of a suitable high density storage device (i.e., atomic resolution storage device) suitable for use as memory 16 with portable entertainment media storage module according to the present invention is disclosed in further detail later in this application.

Memory 16 is especially suitable for storing many different types of entertainment media such as books, music, movies, etc. The entertainment media can be pre-loaded onto memory 16 by the entertainment media outlet or manufacturer so that a purchase of module 10 already includes the desired entertainment media, e.g. a music CD or book. Alternatively, module 10 can be used to capture and store the desired entertainment media by choosing the desired selection from entertainment library 30 and transferring a copy of the selection into memory 16 of module 10 for later retrieval with an entertainment media player. Since memory 16 is so large, multiple entertainment media are loadable into memory 16, thereby permitting repeated use of module 10.

For example, as further shown in FIG. 1, module 10 is usable with entertainment library 30. Entertainment library 30 includes memory 32, controller 34, communication interface 36, display 38, keypad 40, all of which are communicatively coupled together. Communication interface 36 further includes any suitable wireless communication technology such as infrared 42 and radiofrequency 44 communicaton paths, among others.

Entertainment library 30 preferably is available at a shopping center, airport, or other public venue, and hosts in its memory 32 a large selection of books, music, movies and/or other entertainment media in an electronically readable format for purchase via module 10. For example, a user could purchase an electronic book from entertainment library 30 using a credit card and store the electronic book in module 10. In particular, using display 38 and keypad 40, the user manipulates library 30 to choose and purchase one or more selections of an entertainment media (e.g., a book). A copy of that selection is transferred from memory 32 of library 30 via communication interface 36 for storage into memory 16 of module 10 via communication interface 18.

The selected entertainment media is accessed using one of the various entertainment media player schematically illustrated in FIG. 2 that are in wireless (or conventional wired) communication with module 10. Examples of entertainment players for use with personal entertainment media module 10 include eyeglasses 50, headset 60, notebook computer 70, and display 80.

As shown in FIG. 2, eyeglasses 50 include lenses 52, optional speakers 54, optional microphone 56, and communication interface 57, all of which are communicatively coupled together. Eyeglasses 50 are useful for viewing an electronic book or movie in lenses 52. The entertainment media is conveyed from memory 16 of module 10 to eyeglasses via the respective communication interfaces 18 and 57. An image of pages of the book, or frames of the movie, are illuminated on lenses 50 using known imaging technology. Optional speakers 54 are provided for hearing audio components of the book, music or movie. Finally, optional microphone 56 permits a user's comments to be stored in memory 16 of module 10, or for controlling the operation of eyeglasses 50 and/or module 10 using known voice-recognition technology.

In another example of an entertainment media player shown in FIG. 2, headset 60 includes speakers 62, optional microphone 64, and communication interface 66, all of which are communicatively coupled together. Speakers 62 of headset 60 permits hearing an audio selection from memory 16 of module 10 while microphone 64 optionally permits recording a user's voice to memory 16 or controlling operation of headset 60 and/or module 10 via known voice recognition technology. Headset 60 communicates with module 10 via their respective communication interfaces 66 and 18.

Since many consumers of entertainment media already have notebook computers (or even desktop computers), entertainment media stored on module 10 can be enjoyed using a notebook computer. As further shown in FIG. 2, notebook computer 70 includes memory 72, controller 74, communication interface 75, display 76, speaker 78, keypad 79, and microphone 82. The identified components of notebook computer 70 include at least the functions of corresponding components previously identified in eyeglasses 50 and headset 60, as well as the normal functions and capabilities of a known notebook computer. For example, a movie stored in memory 16 of module 10 can be viewed in display 76 and heard in speakers 78 of computer 70 while microphone 80 and/or keypad 79 is used to manipulate display 76, speakers 78 and/or operation of module 10. As with eyeglasses 50 and audio headset 60, known voice recognition technology can be used in association with microphone 80 to control these functions. Of course, notebook computer 70 is capable of handling music CDs, as well as books. For example, page images of an electronic book stored in memory 16 of module 10 can be viewed sequentially or selectively on display 76.

Display 82 includes multi-screen 84 and generally provides an image of a page of an electronic book stored in memory 16 of module 10. Display 82 permits viewing an electronic book without resorting to use of a more powerful, expensive notebook computer 70.

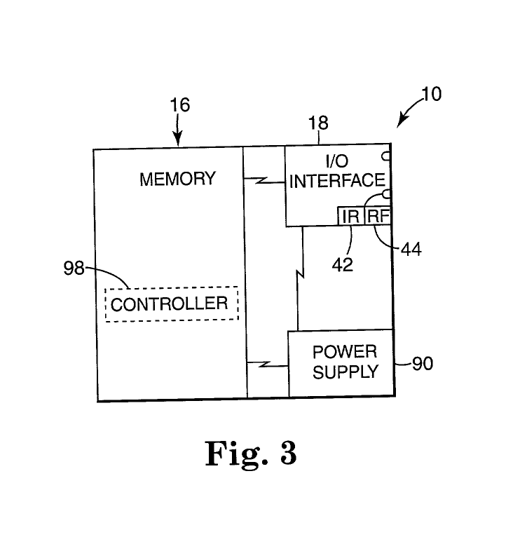

FIG. 3 is a schematic illustration of module 10 which includes memory 16, communication interface 18, and further includes power supply 90. As previously described, communication interface 18 further includes wireless communication technologies such as infrared 42 and radiofrequency 44 communication paths. Memory 16 further includes optional controller 98 for facilitating control of module 10 and/or of other devices used in association with module 10. As previously introduced in association with FIG. 1, memory 16 preferably is a high capacity storage device such as an atomic resolution storage device.

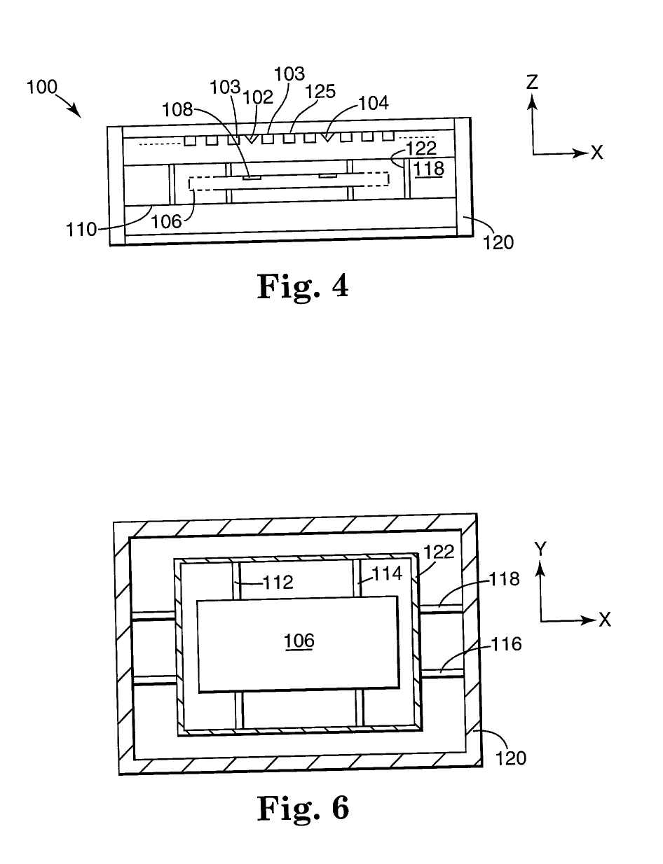

FIGS. 4 through 7 disclose one exemplary embodiment of an atomic resolution storage device of memory 16 capable of storing megabytes to gigabytes of information in a small storage area. For a further discussion of an atomic resolution storage device, see U.S. Pat. No. 5,557,596, entitled, “Ultra-High Density Storage Device”, by Gibson et al. and assigned to Hewlett-Packard Company, which is incorporated herein by reference.

FIG. 4 illustrates a side cross-sectional view of storage device 100. Storage device 100 is one exemplary embodiment of memory 16 of portable entertainment media storage module 10. Storage device 100 includes a number of field emitters, such as field emitters 102 and 104, storage medium 106 including a number of storage areas, such as storage area 108, and micromover 110. Micromover 110 scans storage medium 106 with respect to the field emitters or vice versa. In one preferred embodiment, each storage area is responsible for storing one bit of information.

In one embodiment, the field emitters are point emitters having relatively very sharp points. Each point emitter may have a radius of curvature in the range of approximately 1 nanometer to hundreds of nanometers. During operation, a pre-selected potential difference is applied between a field emitter and its corresponding gate, such as between field emitter 102 and gate 103 surrounding it. Due to the sharp point of the emitter, an electron beam current is extracted from the emitter towards the storage area. Depending on the distance between the emitters and the storage medium 106, the type of emitters, and the spot size (bit size) required, electron optics may be utilized to focus the electron beams. A voltage may also be applied to the storage medium 106 to either accelerate or decelerate the field-emitted electrons or to aid in focusing the field-emitted electrons.

In one embodiment, casing 120 maintains storage medium 106 in a partial vacuum, such as at least 10⁻⁵ torr. It is known in the art to fabricate such types of microfabricated field emitters in vacuum cavities using semiconductor processing techniques. See, for example, “Silicon Field Emission Transistors and Diodes,” by Jones, published in IEEE Transactions on Components, Hybrids and Manufacturing Technology, 15, page 1051, 1992.

In the embodiment shown in FIG. 4, each field emitter has a corresponding storage area. In another embodiment, each field emitter is responsible for a number of storage areas. As micromover 110 scans storage medium 106 to different locations, each emitter is positioned above different storage areas. With micromover 110, an array of field emitters can scan over storage medium 106.

As will be described, the field emitters are responsible to read and write information on the storage areas by means of the electron beams they produce. Thus, field emitters suitable for use in storage device 100 are the type that can produce electron beams that are narrow enough to achieve the desired bit density on the storage medium, and can provide the power density of the beam current needed for reading from and writing to the medium. A variety of ways are known in the art that are suitable to make such field emitters. For example, one method is disclosed in “Physical Properties of Thin-Film Field Emission Cathodes With Molybdenum Cones,” by Spindt et al, published in the Journal of Applied Physics, Vol. 47, No. 12 December 1976. Another method is disclosed in “Fabrication and Characteristics of Si Field Emitter Arrays,” by Betsui, published in Tech. Digest 4^{th} Int. Vacuum Microelectronics Conf., Nagahama, Japan, page 26, 1991.

In one embodiment, there can be a two-dimensional array of emitters, such as 100 by 100 emitters, with an emitter pitch of 50 micrometers in both the X and the Y directions. Each emitter may access tens of thousands to hundreds of millions of storage areas. For example, the emitters scan over the storage areas with a periodicity of about 1 to 100 nanometers between any two storage areas. Also, all of the emitters may be addressed simultaneously or sequentially in a multiplexed manner. Such a parallel accessing scheme significantly reduces access time, and increases data rate of the storage device.

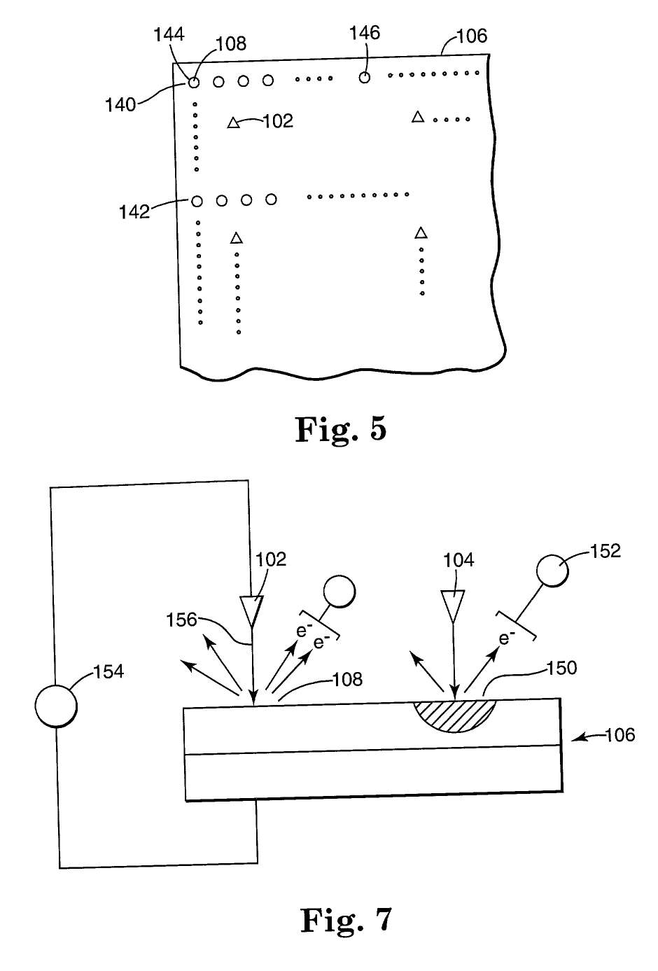

FIG. 5 shows the top view of storage medium 100 having a two-dimensional array of storage areas and a two-dimensional array of emitters. Addressing the storage areas requires external circuits. One embodiment to reduce the number of external circuits is to separate the storage medium into rows, such as rows 140 and 142, where each row contains a number of storage areas. Each emitter is responsible for a number of rows. However, in this embodiment, each emitter is not responsible for the entire length of the rows. For example, emitter 102 is responsible for the storage areas within rows 140 through 142, and within columns 144 through 146. All rows of storage areas accessed by one emitter are connected to one external circuit. To address a storage area, one activates the emitter responsible for that storage area and moves that emitter by micromover 110 (shown in FIG. 4) to that storage area. The external circuit connected to the rows of storage areas within which that storage area lies is activated.

Micromover 110 can also be made in a variety of ways, as long as it has sufficient range and resolution to position the field emitters over the storage areas. As a conceptual example, micromover 110 is fabricated by standard semiconductor microfabrication process to scan storage medium 106 in the X and Y directions with respect to casing 120.

FIG. 6 shows the top view of the cross section 6-6 in FIG. 4, illustrating storage medium 106 held by two sets of thin-walled microfabricated beams. The faces of the first set of thin-walled beams are in the Y-Z plane, such as 112 and 114. Thin-walled beams 112 and 114 may be flexed in the X direction allowing storage medium 106 to move in the X direction with respect to casing 120. The faces of the second set of thin-walled beams are in the X-Z plane, such as 116 and 118. Thin-walled beams 116 and 118 allow storage medium 106 to move in the Y direction with respect to casing 120. Storage medium 106 is held by the first set of beams, which are connected to frame 122. Frame 122 is held by the second set of beams, which are connected to casing 120. The field emitters scan over storage medium 106, or storage medium 106 scans over the field emitters in the X-Y directions by electrostatic, electromagnetic, piezoelectric, or other means known in the art. In this example, micromover 110 moves storage medium 106 relative to the field emitters. A general discussion of such microfabricated micromover can be found, for example, in “Novel Polysilicon Comb Actuators for XY-Stages,” published in the Proceeding of MicroElectro Mechanical Systems 1992, written by Jaecklin et al.; and in “Silicon Micromechanics: Sensors and Actuators on a Chip”, by Howe et al., published in IEEE Spectrum, page 29, in July 1990.

In another embodiment, the electron beam currents are rastered over the surface of storage medium 106 by either electrostatically or electromagnetically deflecting them, such as by electrostatic deflectors or electrodes 125 (shown in FIG. 4) positioned adjacent to emitter 104. Many different approaches to deflect electron beams can be found in literature on Scanning Electron Microscopy and will not be further described in this specification.

In one method, writing is accomplished by temporarily increasing the power density of the electron beam current to modify the surface state of the storage area. Reading is accomplished by observing the effect of the storage area on the electron beams, or the effect of the electron beams on the storage area. For example, a storage area that has been modified can represent a bit 1, and a storage area that has not been modified can represent a bit 0, and vice versa. In fact, the storage area can be modified to different degrees to represent more than two bits. Some modifications may be permanent, and some modifications may be reversible. The permanently modified storage medium is suitable for write-once-read-many memory (WORM).

In one embodiment, the basic idea is to alter the structure of the storage area in such a way as to vary its secondary electron emission coefficient (SEEC), its back-scattered electron coefficient (BEC), or the collection efficiency for secondary or back-scattered electrons emanating from the storage area. The SEEC is defined as the number of secondary electrons generated from the medium for each electron incident onto the surface of the medium. The BEC is defined as the fraction of the incident electrons that are scattered back from the medium. The collection efficiency for secondary/back-scattered electrons is the fraction of the secondary/back-scattered electrons that is collected by an electron collector, typically registered in the form of a current.

Reading is typically accomplished by collecting the secondary and/or back-scattered electrons when an electron beam with a lower power density is applied to storage medium 106. During reading, the power density of the electron beam should be kept low enough so that no further writing occurs.

One embodiment of storage medium 106 includes a material whose structural state can be changed from crystalline to amorphous by electron beams. The amorphous state has a different SEEC and BEC than the crystalline state, which leads to a different number of secondary and back-scattered electrons emitted from the storage area. By measuring the number of secondary and back-scattered electrons, one can determine the stage of the storage area. To change from the amorphous to crystalline state, one increases the beam power density and then slowly decreases it. This heats up the amorphous and then slowly cools it so that the area has time to anneal into its crystalline state. To change from crystalline to amorphous state, one increases the beam power density to a high level and then rapidly decreases the beam power. To read from the storage medium, a lower-energy beam strikes the storage area. An example of such type of material is germanium telluride (GeTe) and ternary alloys based on GeTe. Similar methods to modify states using laser beams as the heating source have been described in “Laser-induced Crystallization of Amorphous GeTe: A Time-Resolved Study,” by Huber and Marinero, published in Physics Review B 36, page 1595, in 1987, and will not be further described here.

There are many preferred ways to induce a state change in storage medium 106. For example, a change in the topography of the medium, such as a hole or bump, will modify the SEEC and BEC of the storage medium. This modification occurs because the coefficients typically depend on the incident angle of the electron beam onto the storage area. Changes in material properties, band structure, and crystallography may also affect the coefficients. Also, the BEC depends on an atomic number, Z. Thus, one preferred storage medium has a layer of low Z material on top of a layer of high Z material or vice versa, with writing accomplished through ablating some of the top layer by an electron beam.

FIG. 7 shows schematically the field emitters reading from storage medium 106. The state of storage area 150 has been altered, while the state of storage area 108 has not been altered. When electrons bombard a storage area, both secondary electrons and back-scattered electrons will be collected by the electron collectors, such as electron collector 152. An area that has been modified will produce a different number of secondary electrons and back-scattered electrons, as compared to an area that has not been modified. The difference may be more or may be less depending on the type of material and the type of modification. By monitoring the magnitude of the signal current collected by electron collectors 152, one can identify the state of and, in turn, the bit stored in, the storage area.

Field emitters may be noisy with the magnitude of the electron beam current varying with respect to time. Moreover, the gap distance between the tips of the emitters and the surface of the storage medium may vary. If the information stored were based on tunneling current, then the gap distance may be extremely crucial. However, the application presently disclosed depends on field emitters, and not directly on the emitted electron beam current, but rather on the effect of the beam. At least two ways may be used to alleviate the problem of the emitters being noisy. One way is to connect constant current source 154 to field emitter 102. This source will control the power density of electron beam current beam 156. Although this method would not help storage techniques using the magnitude of the field emitted current as the signal, this method reduces the field emitter noise significantly. Another way to alleviate the field-emitter noise is to separately measure the emitted electron beam current and use it to normalize the signal current. As the electron beam current varies, the signal current varies correspondingly. On the other hand, the normalized signal current remains the same to indicate the state of the storage area.

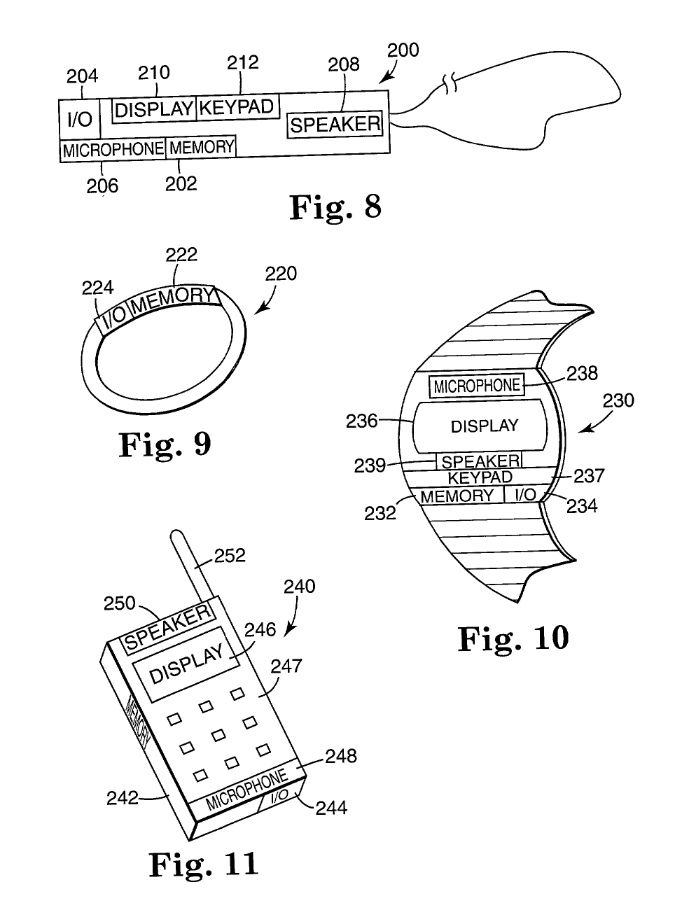

As shown in FIG. 8, module 200 optionally carries additional functions to permit module 200 to operate more independently than module 10. For example, as shown in FIG. 8, module 200 of the present invention includes memory 202 and communication interface 204 and carries substantially the same attributes and features of module 10. However, module 200 optionally further includes one or more of the following components. Module 200 optionally includes microphone 206, speaker 208, display 210, and keypad 212. Microphone 206 and speaker 208 permits recording and retrieving information in memory 202 as well as communicating via voice recognition with other devices used in association with module 200. Likewise, display 210 permits limited visual identification of operation of module 200 including memory 202 and communication interface 204 as well as the status of communication with other devices used in association with module 200.

As shown in FIGS. 9-11, other embodiments of a portable entertainment media storage device of the present invention can be embodied in ordinary portable devices such as a bracelet 220, wrist watch 230, and cellular or mobile phone 240.

As shown in FIG. 9, bracelet 220 includes memory 222 and communication interface 224, and has substantially the same features and attributes of module 10. However, bracelet 220 includes wristband 228 to permit removably securing module 220 to a wrist or other body limb of the user. FIG. 10 includes a watch-based entertainment storage module 230 including memory 232 and communication interface 234, which has substantially the same features and attributes as module 10. In addition, wristwatch-based module 230 optionally further includes display 236, keypad 237, microphone 238, and speaker 239 for further consumption of entertainment media stored in memory 232, communication with other devices, as well as for normal operation of traditional wristwatch functions. Finally, FIG. 11 includes cell-phone based personal entertainment media storage module 240 including memory 242 and communication interface 244, which has substantially the same features and attributes as module 10. However, cell phone 240 further includes display 246, keypad 247, microphone 248, speaker 250, and antenna 252 for further consumption of entertainment media stored in memory 232, communication with other devices, as well as for normal operation of traditional cell phone functions.

Finally, with the widespread advent of wireless communication, information library 30 optionally can be replaced by an e-library, i.e., internet website or other information outlet. In this embodiment, module 10 is used with another device, such as one of the modules 200, 230, 240 that incorporates a display, keypad, microphone, and/or speaker, to facilitate communication with the e-library. Accordingly, while information library 30 provides a convenient point of purchase device for use with module 10, portable entertainment storage module (10, 200, 220, 230, and 240) of the present invention is not limited to receiving its content from information library 30 in a conventional manner (e.g. in person shopping).

A portable entertainment media storage module of the present invention carries many advantageous features. Foremost, the module includes a high capacity storage memory component, such as an atomic resolution storage device, for storing large amounts of information such as one or more books, music CDs, and/or movies, etc. in an extremely small space. This feature permits conveniently transporting an entertainment packet (e.g a book) in a virtually hands-free and almost weightless manner relative to transporting conventional formats such as a printed volume. The entertainment packet can be worn about the body such as in a neck pendant, wristwatch, and cell phone, or simply placed in a pocket of a shirt or pants. Moreover, more than one entertainment media can be handled at once with the module. Accordingly, a user can simultaneously carry and access a movie, music CD, and book, among other items from a module of the present invention, all within a single, lightweight small housing such as a pendant. Handling and consuming entertainment media will see remarkable changes in convenience and enjoyment with this feature.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of handling information comprising:
storing electronically readable information into a portable storage module including an atomic resolution storage memory component; and
recalling selectively a portion of the information from the memory component of the portable module into an information playback device for consumption by a user.

2. The method of claim 1, wherein the storing step further includes transferring the information from an external information source into the memory component of the storage module.

3. The method of claim 2 and the transferring step further comprising:
selecting at least one of a stationary entertainment library and an internet website as the external information source.

4. The method of claim 2 wherein the storing step further comprises:
providing multiple types of entertainment media as the electronically readable information;
storing the entertainment media in the external information source; and
providing the information for user-initiated wireless transfer from the external information source to the storage module.

5. The method of claim 1 and further comprising:
repeating the storing step to capture additional electronically readable information into the memory component of the storage module.

6. The method of claim 1 wherein the recalling step further comprises the information playback device including a notebook computer.

7. The method of claim 1, wherein the recalling step further comprises the information playback device comprising an audio player.

8. The method of claim 1, wherein the electronically readable information is at least one of a book, a music collection, and a movie.

9. The method of claim 1, and further comprising:
containing the module within a housing and wearing the housed storage module on or about a body of a user.

10. The method of claim 9, wherein the containing step further comprises:
arranging the storage module within at least one of a wristwatch, a neck worn pendant, a bracelet, a cellular phone, a pair of eyeglasses, an image display, a notebook computer, and an audio headset.

11. The method of claim 1 wherein, the storing step further comprises:
providing the storage module with a communication interface, and a power supply.

12. The method of claim 11 wherein the providing step further comprises:
providing the communication interface with a wireless communication path including infrared or radiofrequency paths.

13. The method of claim 11 wherein the memory component further includes a controller for operating the storage device and communicating between the memory component and the communication interface.

14. The method of claim 1 and further comprising:
performing the storing step and the recalling step in a broadband frequency format.

15. A portable entertainment media storage module comprising:
a storage device including an atomic resolution storage memory component capable of storing at least one entertainment media packet; and
a communication interface for communicating to and from the memory component of the storage module.

16. The module of claim 15, wherein the communication interface includes wireless communication technology.

17. The module of claim 16 wherein the wireless communication technology includes at least one of a radio frequency communicator and an infrared bandwidth communicator.

18. The module of claim 15, and further comprising at least one of a microphone, a speaker, an input keypad, and a display for communicating with the memory component of the storage device via the communication interface.

19. The module of claim 15, wherein the storage device further includes a logic controller.

20. The module of claim 15, wherein the entertainment packet includes at least one audio element.

21. The module of claim 20, wherein the audio element is a music CD.

22. The module of claim 15, wherein the entertainment packet includes at least one printed media.

23. The module of claim 15, and further comprising a controller located on the atomic resolution storage device.

24. The module of claim 15, wherein the atomic resolution storage device further comprises:
a field emitter fabricated by semiconductor microfabrication techniques capable of generating an electron beam current; and
a storage medium in proximity to the field emitter and having a storage area in one of a plurality of states to represent the information stored in the storage area.

25. The module of claim 24, wherein an effect is generated when the electron beam current bombards the storage area, wherein the magnitude of the effect depends upon the state of the storage area, and wherein the information stored in a storage area is read by measuring the magnitude of the effect.

26. The module of claim 24, further comprising:
a plurality of storage areas on the storage medium, with each storage area being similar to the one recited in claim 24; and
a microfabricated mover in the storage device to position different storage areas to be bombarded by the electron beam current.

27. The module of claim 26, further comprising:
a plurality of field emitters, with each emitter being similar to the one recited in claim 24, the plurality of field emitters being spaced apart, with each emitter being responsible for a number of storage areas on the storage medium; and
such that a plurality of the field emitters can work in parallel to increase the data rate of the storage device.

28. The module of claim 15 further comprising:
a housing which encloses the ultra-high capacity storage device and the communication interface.

29. An information transfer and consumption system comprising:
a portable entertainment media storage module comprising:
an atomic resolution storage device capable of storing at least one entertainment media packet; and
a communication interface for communicating to and from the storage device;
an information library of multiples types of entertainment media stored as electronically readable information including:
a master memory module storing a collection of entertainment media; and
a communication interface for selectively transferring a copy of a selection of the entertainment media collection from the information library to the storage device of the portable entertainment media storage module; and
an entertainment media playback device for retrieving the entertainment media from the storage device of the module and for making the entertainment media available in a consumable format.
